(19) United States
(12) Patent Application Publication
(10) Pub. No.: US 2017/0296429 A1
(43) Pub. Date: Oct. 19, 2017

(54) SYSTEM AND METHOD FOR REDUCING CHRONIC AND ACUTE STRESS

(71) Applicant: VMAS Solutions LLC, Scottsdale, AZ (US)

(72) Inventors: Vicki MAYO, Scottsdale, AZ (US); Amy SERIN, Scottsdale, AZ (US)

(21) Appl. No.: 15/345,916

(22) Filed: Nov. 8, 2016

Related U.S. Application Data
(60) Provisional application No. 62/324,023, filed on Apr. 18, 2016.

(51) Int. Cl. A61H 23/02

(52) U.S. Cl. CPC A61H 23/02; A61H 2205/065; A61H 2201/5038; A61H 2201/5043; A61H 2201/5097

(57) ABSTRACT

A method for providing a therapeutic benefit to a patient includes positioning a first tactile stimulator in therapeutic contact with a body of a patient and positioning a second tactile stimulator in therapeutic contact with the body of the patient in a bilateral position to the first tactile stimulator. A controller (mobile device) activates the first tactile stimulator to provide a first stimulation for a first time period and activating the second tactile stimulator to apply a second stimulation for a second time period beginning at least commensurate with a cessation of the first time period. This process is repeated for a therapeutically effective number of repetitions so that the first and second stimulations are applied bilaterally to the body of the patient without a patient perceivable pause in stimulation between the first stimulation and second stimulation to provide the therapeutic benefit to the patient

### RELATED APPLICATION

This application claims the benefit of U.S. Provisional Application No. 62/324,023 filed Apr. 18, 2016.

### TECHNICAL FIELD

The technical field generally relates to stress reduction, and more particularly relates to a system and method for reducing chronic and acute stress to improve performance.

### BACKGROUND

Chronic stress is one of the most pervasive psychological complaints. Chronic stress has been linked to digestive distress, headaches, depression, sleep problems, weight gain, underachievement, panic, avoidance, and poor physical health. Acute stress is the precursor to chronic stress and generally is more pervasive in individuals than chronic stress. When acute stress triggers the sympathetic nervous system, performance worsens. Returning an individual to a calm state as soon as possible is desirable. Once acute stress is experienced over time, the brain develops neural “habits” that overemphasize the stress response. When chronic stress ensues it can create chronic mental illness and physical disease. Chronic stress is known to increase body inflammation and is considered to be the root cause of significant suffering, often impeding performance and the ability to carry out normal daily activities to one's potential.

In many adults, chronic stress begins as acute stressors in childhood that result from genetic predispositions, and/or traumatic physical or emotional distress. Stress adversely impacts brain development and creates over activation of the sympathetic nervous system, resulting in performance degradation, preoccupation, depression, anxiety, over-reactivity, and sub-optimal functioning in other areas of the brain. The brain's structure and function can be significantly altered in ways that promote ongoing stress and less adaptability. The more chronic stress experienced in childhood has been shown to correlate with a number of negative outcomes related not only to psychological problems, but also physical disease and mortality.

Accordingly, it is desirable to provide methods and systems for disrupting the brain's habit of over-activating the sympathetic nervous system as a result of chronic stress. It is further desirable that the systems and methods are easy to use and do not impede individuals mobility or performance of their job or other everyday tasks. Other desirable features and characteristics will become apparent from the subsequent summary and detailed description and the appended claims, taken in conjunction with the accompanying drawings and the foregoing technical field and background.

### BRIEF SUMMARY

Various non-limiting embodiments of an alternating bi-lateral stimulation system and method for providing a therapeutic benefit to a patient are disclosed herein.

In a first non-limiting embodiment, a method for providing a therapeutic benefit to a patient, includes, but is not limited to positioning a first tactile stimulator in therapeutic contact with a body of a patient. The method further includes, but is not limited to positioning a second tactile stimulator in therapeutic contact with the body of the patient in a bilateral position to the first tactile stimulator. The method further includes, but is not limited to activating the first tactile stimulator to provide a first stimulation for a first time period and activating the second tactile stimulator to apply a second stimulation for a second time period beginning at least commensurate with a cessation of the first time period. This process is repeated for a therapeutically effective number of repetitions so that the first and second stimulations are applied bilaterally to the body of the patient without a patient perceivable pause in stimulation between the first stimulation and second stimulation to provide the therapeutic benefit to the patient.

In another non-limiting embodiment, a system for providing a therapeutic benefit to a patient includes, but is not limited to, first and second tactile stimulators bilaterally positioned in therapeutic contact with a body of a patient. The system further includes, but is not limited to, a controller communicably coupled to the first and second tactile simulators, the controller causing the first tactile stimulator to apply a first stimulation for a first time period and causing the second tactile stimulator to apply a second stimulation for a second time period beginning at least commensurate with a cessation of the first time period. So configured, the system provides a therapeutic benefit to the patient by the first and second stimulations being applied bilaterally to the body of the patient without a patient perceivable pause in stimulation between the first stimulation and second stimulation provide the therapeutic benefit to the patient.

In another non-limiting embodiment, a non-transitory computer readable medium embodying a computer program product includes, but is not limited to, instructions for providing a therapeutic benefit to a patient when executed by a processor. The instructions cause the processor to communicate with first and second tactile stimulators bilaterally positioned on the patient's body and activate the first tactile stimulator to apply a first stimulation for a first time period and activate the second tactile stimulator to apply a second stimulation for a second time period beginning at least commensurate with the processor instructing the first tactile stimulator to cease applying the first stimulation. In this way, the instructions contained in the non-transitory computer readable medium cause the first and second stimulations to apply alternating bilateral stimulation to the patient without a patient perceivable pause in stimulation between the first stimulation and second stimulation to provide the therapeutic benefit to the patient.

### DESCRIPTION OF THE DRAWINGS

Embodiments of the present invention will hereinafter be described in conjunction with the following drawing figures, where like numerals denote like elements, and:

FIG. 1 is an illustration of a bilateral stimulation system in accordance with a non-limiting embodiment;

FIG. 2 is a block diagram of the stimulation elements of FIG. 1 in accordance with a non-limiting embodiment;

FIGS. 3A-3B are illustrations of non-limiting embodiments of the stimulation elements of FIG. 2;

FIG. 4 is an illustration of a securing band that can be used with the stimulation element of FIG. 3B in accordance with a non-limiting embodiment;

FIGS. 5A-5B are illustrations of a wristband that can be used with the stimulation element of FIG. 3B in accordance with a non-limiting embodiment;

FIG. 6 is an illustration of a fitness monitor for use with the stimulation elements in accordance with a non-limiting embodiment;

FIG. 7 is an illustration of a wristwatch for use with the stimulation elements in accordance with a non-limiting embodiment;

FIG. 8 is an illustration of an alternate embodiment employing multiple stimulation elements on either lateral side of an individual in accordance with a non-limiting embodiment;

FIG. 9 is an illustration of an individual showing exemplary positions for the stimulation elements in accordance with non-limiting embodiments;

FIG. 10 is an illustration of a mobile device screen-shot for programming the stimulation applied by the stimulation elements in accordance with non-limiting embodiments;

FIGS. 11-14 are illustrations of programming one parameter of the stimulation elements in accordance with a non-limiting embodiment;

FIGS. 15A-15C are illustrations of timing diagrams for applying stimulation via the stimulation elements in accordance with non-limiting embodiments;

FIG. 16 are illustrations of various permutations of operating modes of the present disclosure in accordance with non-limiting embodiments;

FIG. 17 is a flowchart of a method in accordance with a non-limiting embodiment;

FIGS. 18A-18B are illustrations demonstrating the benefits of the present disclosure in accordance with non-limiting embodiments; and

FIG. 19 is an illustration of an veterinary patient showing exemplary positions for the stimulation elements in accordance with non-limiting embodiments;

### DETAILED DESCRIPTION

As used herein, the word “exemplary” means “serving as an example, instance, or illustration.” The following detailed description is merely exemplary in nature and is not intended to limit application and uses. Any embodiment described herein as “exemplary” is not necessarily to be construed as preferred or advantageous over other embodiments. All of the embodiments described in this Detailed Description are exemplary embodiments provided to enable persons skilled in the art to make or use the embodiment and not to limit the scope that is defined by the claims. Furthermore, there is no intention to be bound by any expressed or implied theory presented in the preceding Technical Field, Background, Drawings Summary or the following Detailed Description.

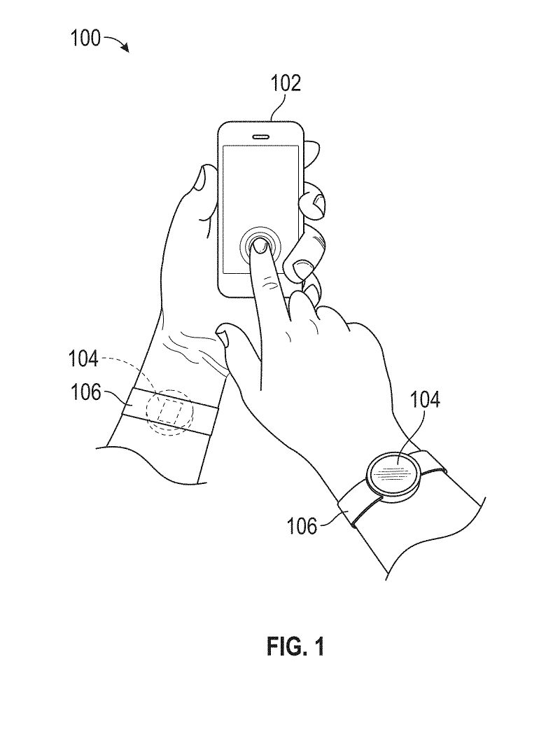

FIG. 1 is an illustration of a bilateral stimulation system 100 in accordance with a non-limiting embodiment. The stimulation system 100 is said to be bilateral, as stimulation is applied to opposing sides of individual's body. In the embodiment illustrated in FIG. 1, vibrating elements 104 are coupled to the individual's wrists by a band 106. The vibrating elements 104 are controlled by a mobile device 102 (e.g., cell phone, tablet computer, personal digital assistant or remote control device) running a software application (or app) that wirelessly communicates with the vibrating elements 104 via the mobile device 102 causing them to vibrate.

In one exemplary embodiment, bi-lateral asynchronous stimulation is provided by the vibrating elements 104. As used herein, “asynchronous” means to stimulate each vibrating element 104 in an alternating manner with some period of overlap where both stimulating elements are vibrating simultaneously. The overlap area may begin randomly or may be programed as will be discussed below. The vibrating elements 104 alter the brain's internal communication in multiple areas including the somatosensory cortex and other brain networks. This interferes with the brain's ability to activate the sympathetic nervous system and therefore reduces the stress response. By applying the bi-lateral and asynchronous stimulation to the individual's body, the individual experiences a reduction in stress and a lessening of distressing body sensations (e.g., racing heartbeat, stomach aches). Because the brain can activate sympathetic arousal in hundreds of milliseconds (or faster via the brain's primitive routes of processing), the overlap period provides an advantage over conventional bi-lateral stimulators in ensuring that any stimulation gap commonly used in conventional bi-lateral stimulators will not allow the brain to activate the sympathetic system. The stimulation provided during the overlap period also enhances bi-lateral impact in the somatosensory areas of the individual's brain.

In another exemplary embodiment, continuous bi-lateral stimulation is provided by the vibrating elements 104. As used herein, “continuous” means to stimulate each vibrating element 104 in an alternating manner without any gap or pause between the stimulation being applied to opposing (bi-lateral) sides of the body. Similar to asynchronous stimulation, continuous bi-lateral stimulation alters the brain's internal communication in multiple areas including the somatosensory cortex and other brain networks continuously so as not to provide time for the brain to activate the sympathetic system.

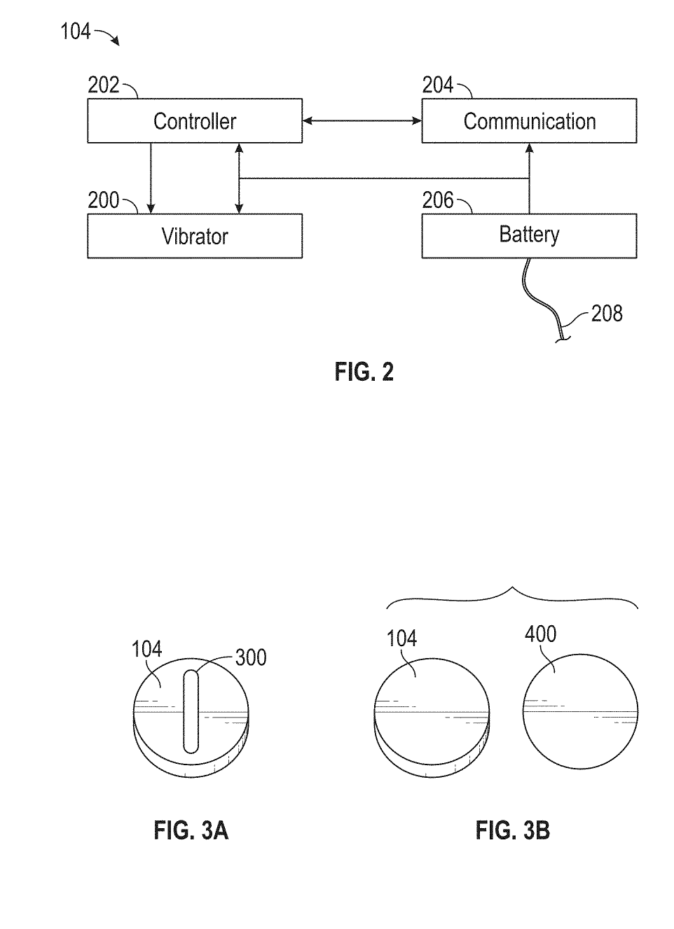

Referring now to FIG. 2, a block diagram of a vibrating element 104 is shown. The vibrating element includes a vibrator 200, which in some embodiments is a piezoelectric vibrator as is known in the art. The vibrator 200 is controlled by a controller 202 which receives instructions via the communication module 204 from the mobile device 102 (see FIG. 1). A battery 206 provides power to each of the components of vibrating element 104. The battery 206 may utilize any suitable battery chemistry, including, but not limited to, alkali, metal-hydride, lithium and maybe rechargeable or replaceable depending upon the implementation in any given embodiment. In some embodiments, the battery 206 may be coupled via cable 208 to power or recharge the battery 206 from a supplemental power source (not shown in FIG. 2) such as the mobile device 102 (see, FIG. 1). The cable 208 may be fitted with a micro USB connector or other suitable connector as will be appreciated by those skilled in the art. The communication module 204 may be any form of low-power wireless communication (e.g., BLUETOOTH, WIFI). In some embodiments, controller 202 comprises one or more processors. The processor(s) may reside in single integrated circuit, such as a single or multi-core microprocessor, or any number of integrated circuit devices and/or circuit boards working in cooperation to accomplish the functions of the controller 202. The processor(s) may be a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. The controller 202 may also contain a memory system, such as non-volatile memory (e.g., Read Only Memory (ROM), flash memory, etc.), volatile memory (e.g., Dynamic Random Access Memory (DRAM)), or some combination of the two.

FIGS. 3A and 3B are illustrations of two non-limiting embodiments of the vibrating element 104. In FIG. 3A, the vibrating element 104 is a fixed with a clip 300 that an individual can attach to a band around a portion of individuals body (e.g., wrist, arm, chest, leg) to position the vibrating element 104. In the embodiment illustrated in FIG. 3B, the vibrating element 104 may be temporarily fixed to an individual's body by a removable adhesive disc 400. In still other embodiments a hook-and-eye attachment mechanism maybe used as is known in the art.

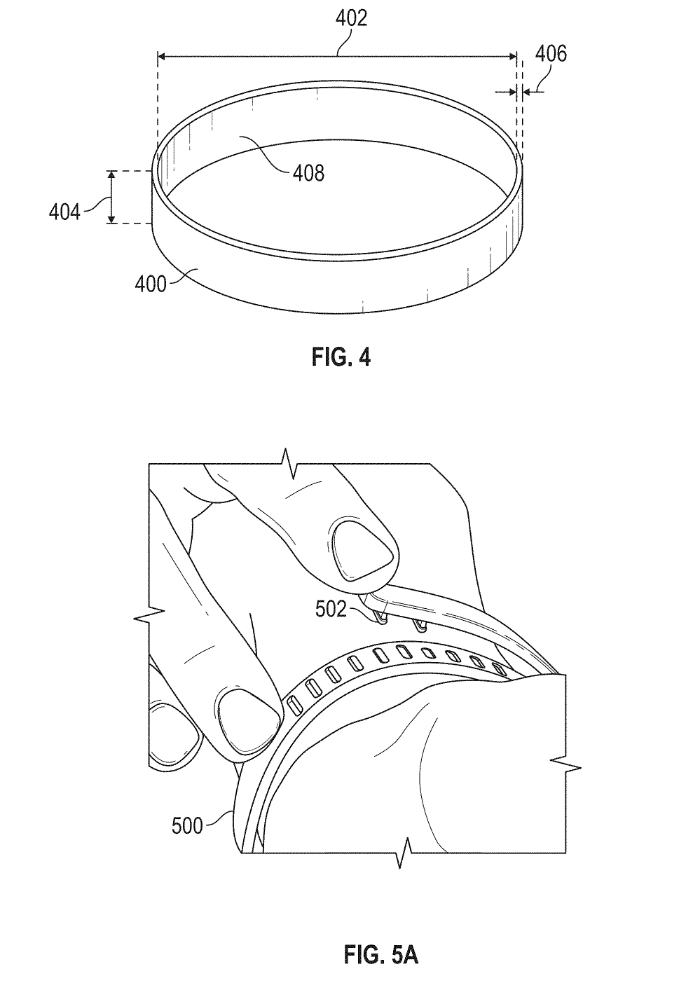

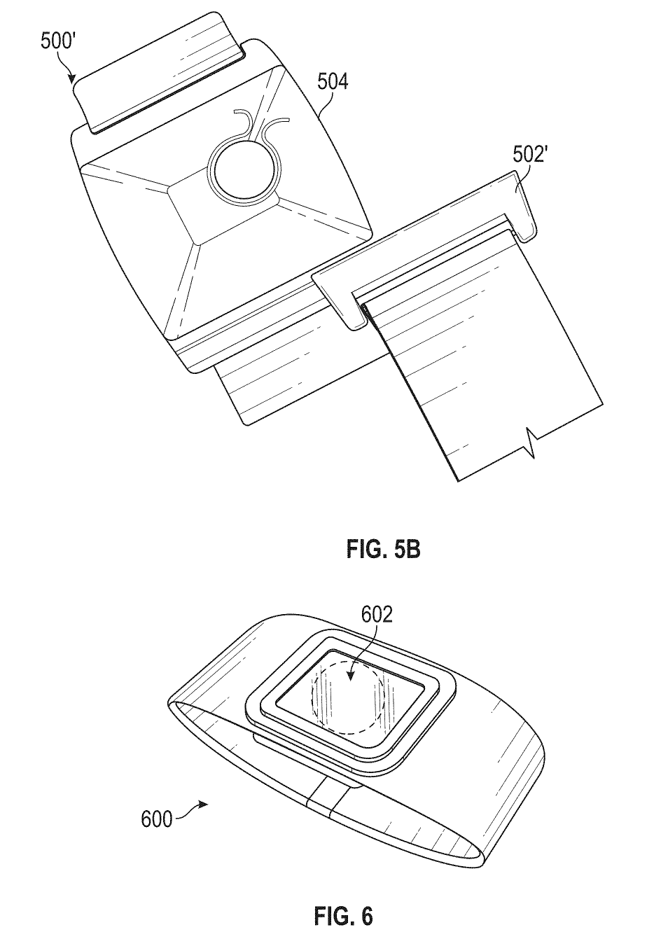

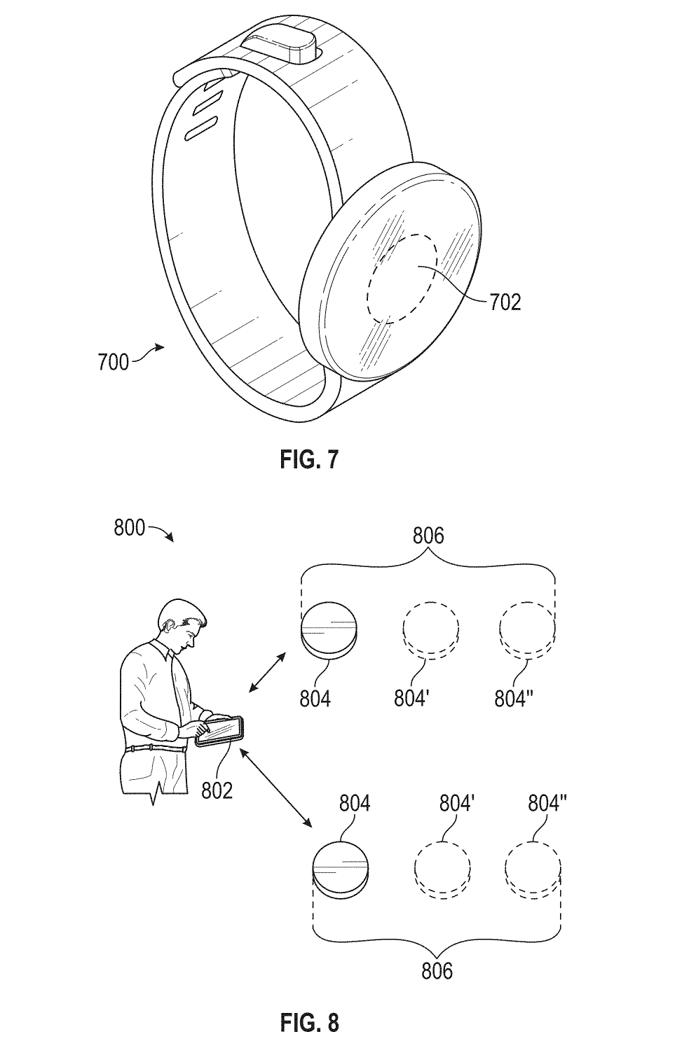

With continued reference to FIGS. 1-3, FIGS. 4-7 illustrate other non-limiting techniques for positioning a vibrating element 104 on an area of an individual's body. In FIG. 4, a securing band 400 is shown. The securing band 400 may be compliant, elastic or may be secured using a hook-and-eye arrangement as is known in the art. The securing band 400 has a diameter 402, a height 404 and a thickness 406 sized suitably for the area of the individuals body (e.g., wrist, arm, chest, leg, ankle) that the band 400 will be placed around. The thickness 406 is also selected to facilitate attachment of the vibrating element 104 by the clip 300 (see FIG. 3A). The securing band 400 has an interior surface 408 upon which a material can be placed for the individual's comfort or to absorb moisture. In FIG. 5A, a wristband 500 is illustrated that may be used to position the vibrating elements 104 about an individual's wrist. The wristband 500 has an attachment mechanism 502 for securing the vibrating element 104 to the individual's wrist. The attachment mechanism 502 may be any suitable attachment mechanism such as those used to attach a wristwatch or fitness monitor to a person's wrist. In FIG. 5B, a wristband 500′ is illustrated for positioning a vibrating element 504 about an individual's wrist. The wristband 500′ has a sliding attachment mechanism 502′ for securing the vibrating element 504 to the individual's wrist. The wristband 500 or 500′ may be formed of plastic, leather, fabric, metal or other suitable material and may be designed to be worn casually or as a fashion accessory. The vibrating elements 104 may also be combined into other devices. For example, FIG. 6 illustrates a wrist-worn fitness monitor 600 that includes a recess 602 on the interior portion of the device sized suitably to receive a vibrating element 104. The vibrating element 104 may be placed in the recess 602 by a friction-fit arrangement or by use of a removable adhesive disc (see FIG. 3B). Similarly, FIG. 7 illustrates a wristwatch 700 having a recess 702 on an interior portion to receive the vibrating element 104 as described above.

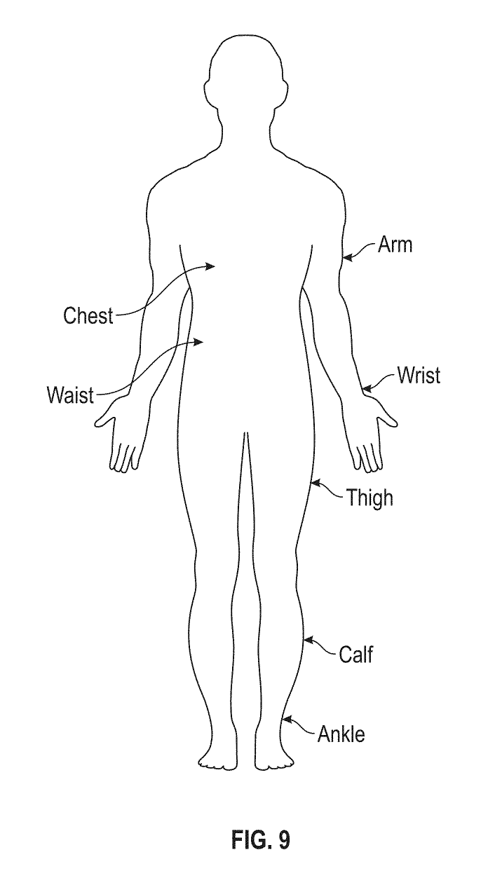

Referring now to FIG. 8, an alternate non-limiting embodiment of an asynchronous bilateral stimulator 800 is shown. In the embodiment of FIG. 8, multiple vibrating elements 804, 804′ and 804″ are arranged in vibrating arrays 806 such that multiple vibrating elements may be placed at various points (e.g., wrist, chest and ankle) bilaterally on individual's body. FIG. 9 is a line-drawing of an individual's body illustrating various non-limiting positions were a vibrating element 104 (or vibrating elements of an array 806) may be positioned. As used herein, a vibrating element 104 being brought into position or placed on individual body means being brought into “therapeutic contact” with an individual's body. Therapeutic contact may be achieved by direct contact (e.g., hand held, secured via adhesive or placed via a strap) or via indirect contact (e.g., through clothing, a coupling gel or through a wearable device). Accordingly, therapeutic contact means only that the individual need be able to perceive the stimulation provided by the bilateral vibrating elements 104 during therapy. Those skilled in the art will appreciate that more or fewer vibrating elements 804 may be used in any particular vibrating array 806. In operation, the mobile device 802 communicates wirelessly with each vibrating element in vibrating array 806 causing one array to vibrate for a time period, then both arrays to vibrate simultaneously for an overlap period, and then the alternate array to vibrate for the time period. In various non-limiting embodiments, the time period of vibration, the intensity of the vibration and the overlap time period are programmable by the individual as will be discussed below.

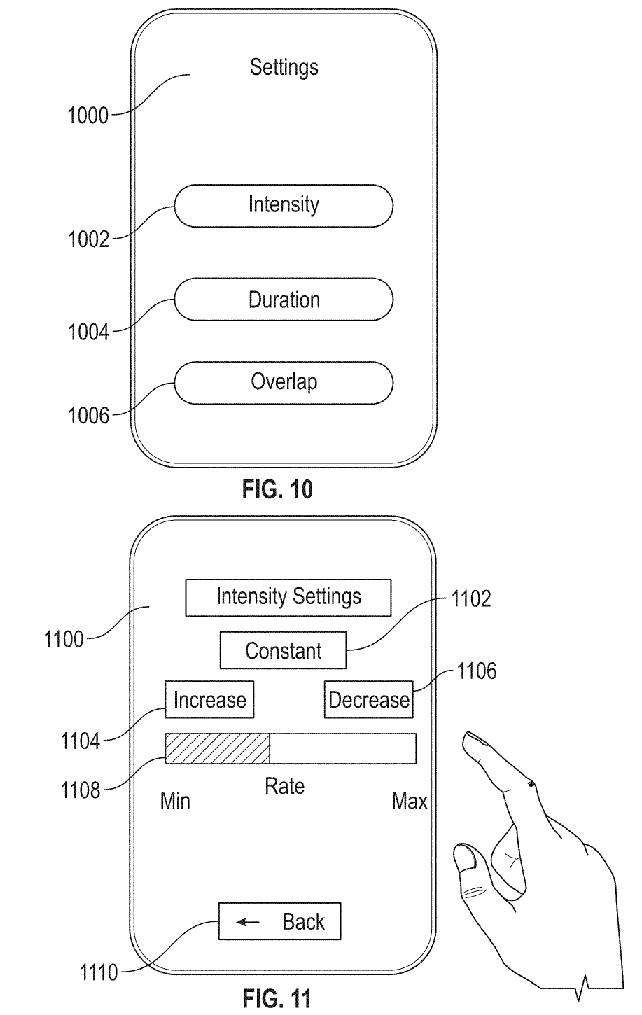

FIGS. 10-14, are non-limiting illustrations of a display screen of the mobile device (102 or 802) that may be used to program the alternating asynchronous bilateral simulation of the bilateral stimulation system (100 or 800). In FIG. 10, a settings screen 1000 is illustrated having a touch-sensitive button 1002 to adjust the intensity of the vibrations, a button 1004 to adjust the duration of the vibrations and a button 1006 to adjust the overlap period during which both vibrating elements 104, or both vibrating arrays 806, are simultaneously applying stimulation to an individual's body. If no settings are provided (programed) by the individual, the continuous bi-lateral stimulation mode is selected, with constant intensity and speed over the stimulation time periods.

FIG. 11 illustrates an example where the intensity button 1002 has been activated by the individual. According to exemplary embodiments, the intensity of stimulation during the stimulation time period may be constant, gradually increasing or gradually decreasing. Accordingly, the intensity setting screen 1100 include selection buttons for selecting (programming) constant 1102, increasing 1104 or decreasing 1106 stimulation. In one non-limiting embodiment, when a user selects either the increasing button 1104 or the decreasing button 1106, a slide-bar adjustment area 1108 become active so that the individual may drag an indicator from a minimum (“Min”) setting to a maximum (“Max”) setting as shown. Additionally, the intensity settings screen 1100 presents individual with a touch-sensitive back button 1110 to return to the setting screen 1000 of FIG. 10.

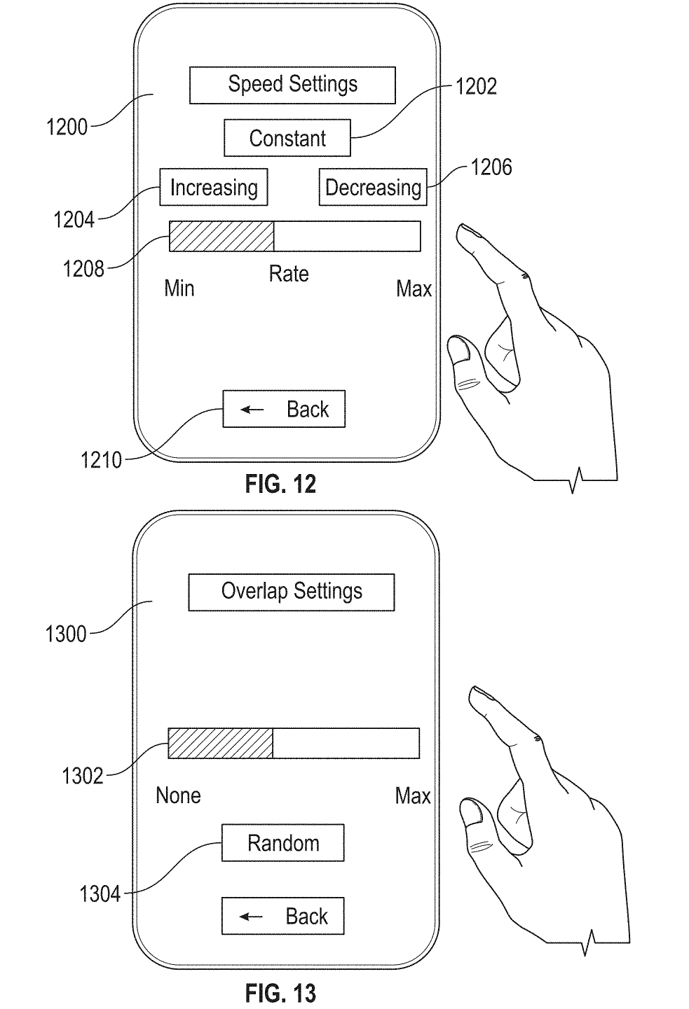

FIG. 12 illustrates an example where the speed button 1004 has been activated by the individual. According to exemplary embodiments, the speed that the stimulation is applied during the stimulation time period may be constant, gradually increasing or gradually decreasing. Accordingly, the speed setting screen 1200 include selection buttons for selecting (programming) constant 1202, increasing 1204 or decreasing 1206 stimulation speed. In one non-limiting embodiment, when a user selects either the increasing button 1204 or the decreasing button 1206, a slide-bar adjustment area 1208 become active so that the individual may drag an indicator from a minimum (“Min”) setting to a maximum (“Max”) setting as shown. Additionally, the speed settings screen 1200 presents individual with a touch-sensitive back button 1210 to return to the setting screen 1000 of FIG. 10.

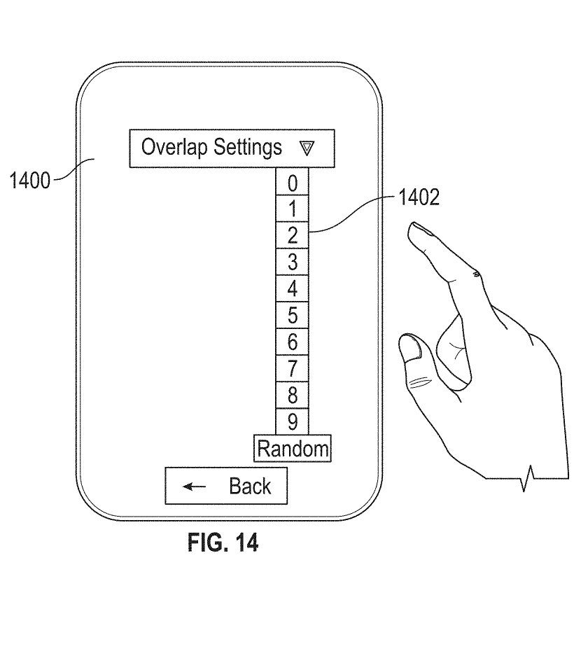

FIG. 13 illustrates an example where the overlap button 1006 has been activated by the individual. In one non-limiting embodiment, the overlap settings screen 1300 includes a slide-bar adjustment area 1302 so that the individual may drag an indicator from a “none” setting (continuous bi-lateral stimulation mode) to a “maximum” overlap setting as shown. Additionally, the overlap settings screen 1300 presents individual with a touch-sensitive randomize button 1304. When the randomize button 1304 is selected by the individual, the time period in which both vibrating elements 104 (or vibrating arrays 806) simultaneously vibrate is randomly selected by the controller (202 of FIG. 2) as will be discussed below. In FIG. 14, an alternate non-limiting embodiment of an overlap settings screen 1400 is illustrated having a drop-down menu 1402 in which the period of overlap (“0” being the continuous bi-lateral stimulation mode), or the random setting, may be selected by the individual. As will be appreciated by those skilled in the art, the screen format illustrated in FIG. 14 may also be used for adjusting the intensity setting (FIG. 11) and the speed setting (FIG. 13).

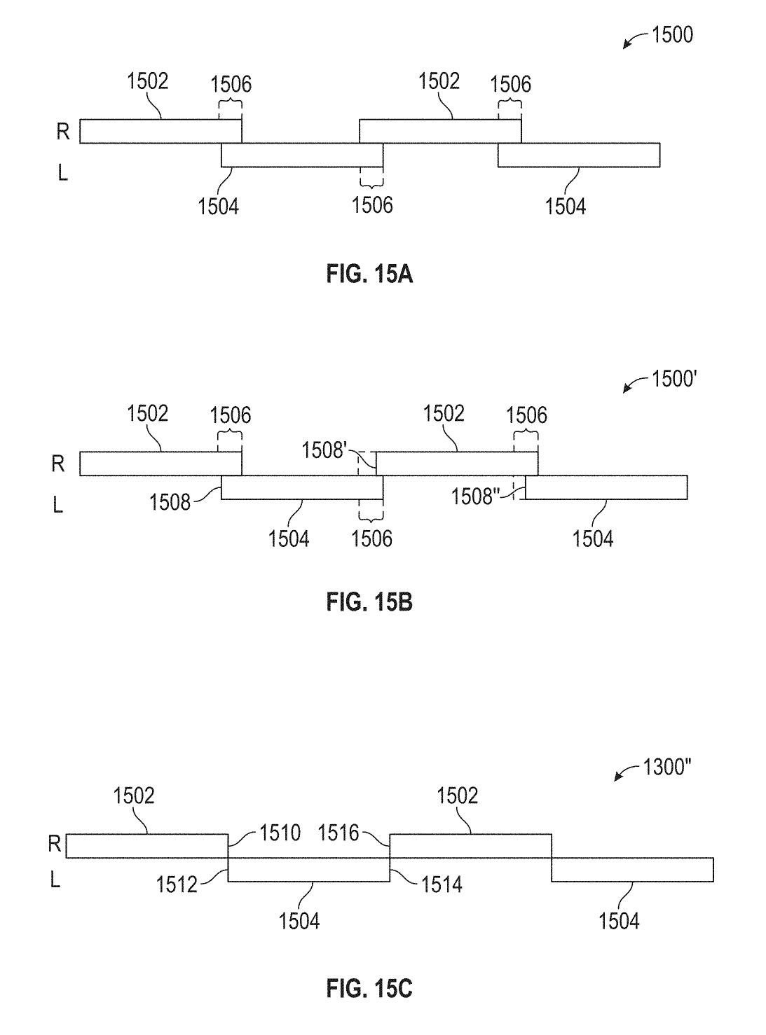

FIGS. 15A-15B are timing diagrams illustrating non-limiting embodiments of the alternating asynchronous bilateral stimulation as contemplated by the present disclosure. In FIG. 15A, a timing diagram 1500 illustrates a time period 1502 during which one of the vibrating elements 104 (designated “R” for a right side of an individual's body) is vibrating. It will be appreciated that the time period 1502 would also be the time period that the vibrating array 806 is vibrating in the embodiment of FIG. 8. Timing diagram 1500 also includes a time period 1504 during which the opposite side (designated “L” for a left side of an individual's body) vibrating element 104 is vibrating. An overlap time period 1506 is also illustrated during which both vibrating elements 104 are simultaneously vibrating. In the embodiment of FIG. 15A, the duration of the overlap period 1506 is programmed by the individual in any suitable manner, including the non-limiting examples provided in connection with FIGS. 13-14. In FIG. 15B, the randomize option has been selected by the individual (see 1304 of FIG. 13) which causes the time period in which both vibrating elements are simultaneously vibrating to be randomly selected between vibrating cycles from one side of the individual's body to the bilateral (opposite) side. As an example, and not as a limitation, observing from the left-side to the right-side of FIG. 15B shows a leading-edge (meaning the beginning of the vibration period 1504) 1508 beginning at the maximum point (most amount of simultaneous vibration) of the overlap time period 1506. The leading-edge 1508′ of time period 1502 can be seen to have a shorter time of overlapping vibrations. Moving on, leading-edge 1508″ of time period 1504 can be seen to begin at about the midpoint of the overlap time period 1506. In the embodiment illustrated by timing diagram 1500′ the alternating vibrations would continue to randomly overlap within the overlap time period 1506 until the individual deactivates the vibrating elements by controlling the mobile device 102 (or 802).

FIG. 15C is a timing diagram illustrating non-limiting embodiments of the alternating continuous bilateral stimulation as contemplated by the present disclosure. In FIG. 15C, a timing diagram 1500″ illustrates a time period 1502 during which one of the vibrating elements 104 (designated “R” for a right side of an individual's body) is vibrating. It will be appreciated that the time period 1502 would also be the time period that the vibrating array 806 is vibrating in the embodiment of FIG. 8. Timing diagram 1500 also includes a time period 1504 during which the opposite side (designated “L” for a left side of an individual's body) vibrating element 104 is vibrating. As illustrated in FIG. 15C, at the conclusion (trailing edge 1510) of the vibrating time period 1502, the vibrating period 1504 begins (leading edge 1512) without pause or interruption in the simulation being applied to the individual. As such, this form of stimulation is said to be continuous bi-lateral stimulation. Similarly, at the conclusion (trailing edge 1514) of the vibrating time period 1504, the vibrating period 1502 begins again (leading edge 1516) also without pause or interruption in the simulation being applied to the individual.

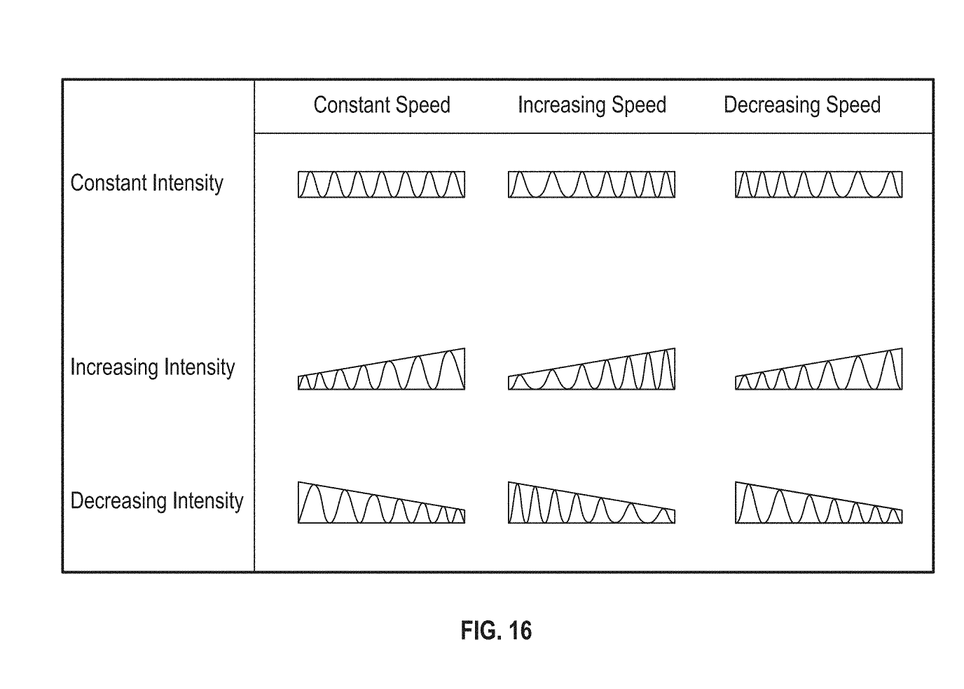

FIG. 16 illustrates some of the possible operating modes of the system of the present disclosure to provide the therapeutic benefit afforded by the method disclosed herein. As discussed above in connection with FIGS. 15A-15C, one mode of operation focuses on whether the system is providing alternating asynchronous bilateral stimulation (fixed or random overlap) or alternating continuous bilateral stimulation (no gap or pause between left and right simulations). Additionally, as shown in FIG. 16, the intensity and the speed of stimulation may be constant, gradually increasing or gradually decreasing over the stimulation period leading to the nine operating modes illustrated in FIG. 16. A patient can vary the settings (see, FIGS. 10-14 and associated text) to find the mode of operation that provides the greatest benefit to that patient under the present circumstances.

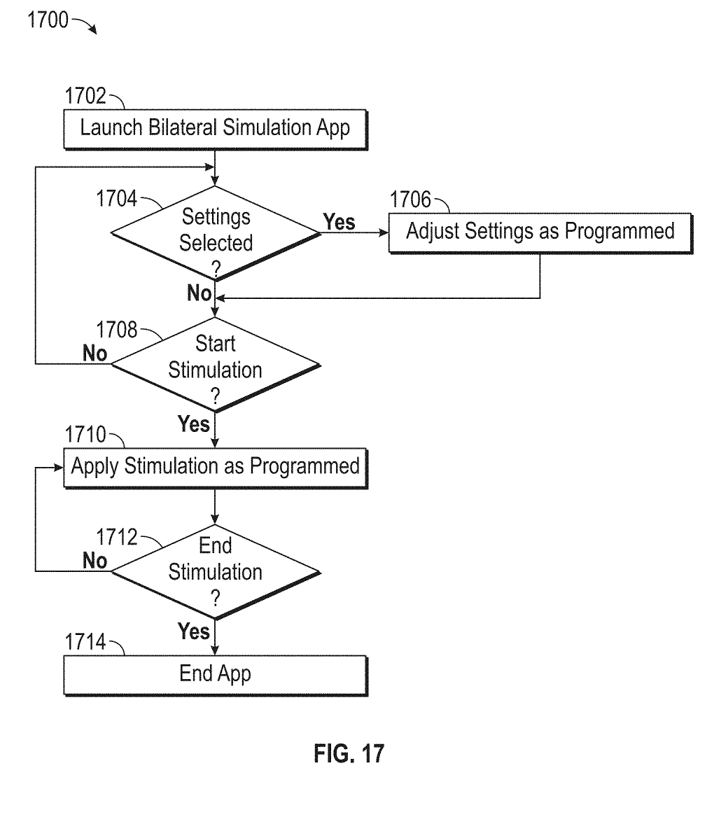

FIG. 17 is a flow diagram of a method 1700 performed by the bilateral stimulation system in accordance with a non-limiting embodiment. In one embodiment, the various tasks performed in connection with the method 1700 of FIG. 17 are performed by instruction stored on a non-transitory computer medium being executed in a processing unit, hardware, firmware, or any combination thereof.

For illustrative purposes, the following description of the method 1700 of FIG. 17 refers to elements mentioned above in connection with FIG. 1 to FIG. 16.

It should be appreciated that the method of FIG. 17 may include additional or alternative tasks, or may include any number of additional or alternative tasks, and that the method of FIG. 17 may be incorporated into a more comprehensive procedure or process having additional functionality not described in detail herein or implemented as a stand-alone procedure. Moreover, one or more of the tasks shown in FIG. 17 are removable from an embodiment of the method 1700 of FIG. 17 as long as the intended overall functionality remains intact.

The method begins in block 1702 where the bilateral stimulation application (app) is launched (begun) on the mobile device 102 so that the individual may receive the asynchronous (or continuous) alternating bilateral stimulation as discussed above. In block 1704, a determination is made as to whether the individual has selected a settings feature to adjust the programming of the stimulation as discussed above in connection with FIGS. 10-14. If the determination of block 1704 is that the individual has elected to adjust the programming of the stimulation, the method proceeds to block 1706 where the settings are adjusted as desired by the individual as discussed above. Conversely, if the determination of block 1704 is that the individual has not elected to change the stimulation programming, the routine proceeds to block 1708 to determine whether the individual has activated the stimulation. If not, the routine loops around to block 1704 and routine continues. Assuming the determination of block 1708 is that the individual desires to commence simulation, the simulation is applied in asynchronous (or continuous) and alternate manner in block 1710 as discussed above. The stimulation can continue for a time period of until the individual decides to stop the stimulation as determined in block 1712, at which point the application ends in block 1714. Otherwise, the routine loops back to step 1710 and the stimulation is continued for a predetermined time period or for any time period desired by the individual.

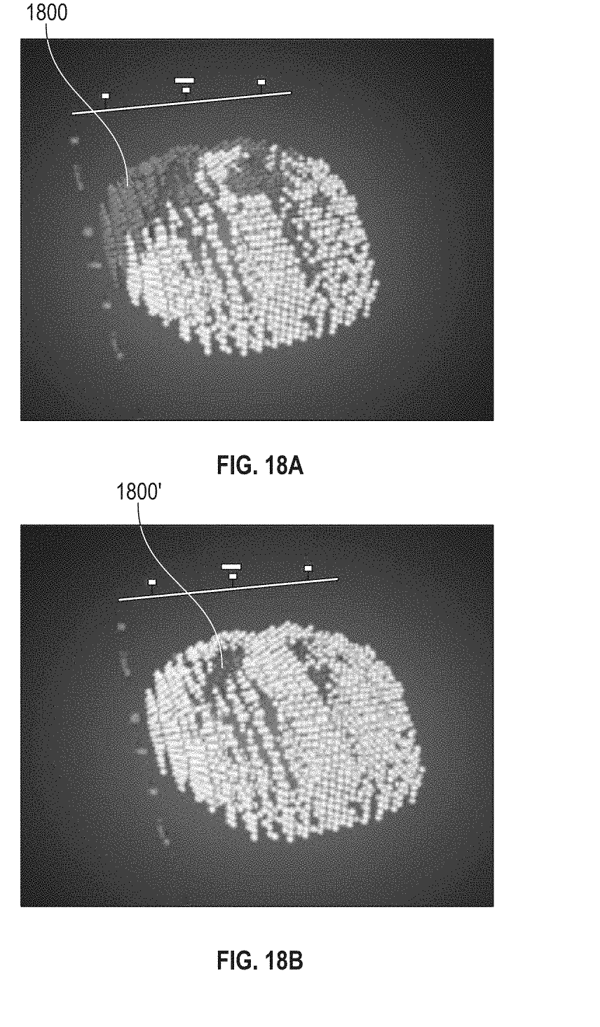

As a non-limiting practical example of the therapeutic benefits afforded by the present disclosure, FIGS. 18A-18B are brain images showing qEEG results using a Cognionics Quick-20 Dry Headset, Neuroguide (version 2.8.7), and LFT Tools Software for analysis. In this example, the patient is a 38 year old male CEO experiencing excess beta activity 1800 as seen in FIG. 18A. After thirty second of applied therapeutic treatment according to the present disclosure (patient eyes open in a resting state condition), is significantly reduced 1800′ demonstrating the significant advantages of the present disclosure. Additionally, other objective tests can verify the therapeutic benefit afforded by the present disclosure. Non-limiting examples of such test include, motor control tests, cognitive state tests, cognitive ability tests, sensory processing tests and performing standardized cognitive tasks.

While the present disclosure has been described in terms of improving patient performance by reduction in acute or chronic stress, it will be appreciated by those skilled in the art that the therapeutic benefits offered by the present disclosure can aid in treating: attention deficit disorder, obsessive/compulsive disorder, clinical depression, panic disorder, anxiety, eating disorder, sleep disorder and learning disabilities. The stress relieving benefits of the present disclosure can assist patient in real or imagined situations in everyday live, relieve stress or anxiety prior to surgery or a medical procedure (or themselves or a family member), relieve post-surgical and physical therapy stress during recovery.

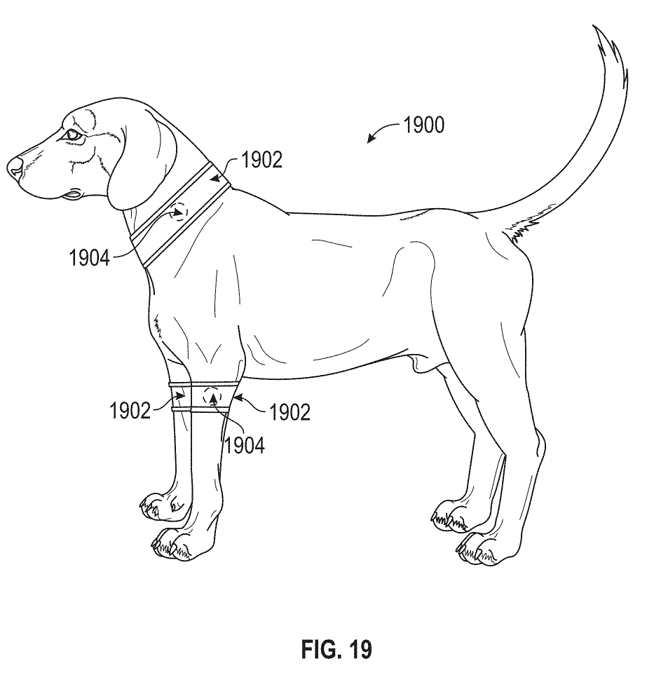

Additionally, the benefits afforded by the present disclosure are not limited to human patients. Veterinary patients can also benefit as show in FIG. 19. As illustrated in this non-limiting example, a veterinary patient 1900 (a dog in this example) has a band 1902 (similar to that discussed in connection with FIG. 4 having bi-laterally placed (one shown in FIG. 19) vibrating stimulation elements 1904 (similar to vibrating elements 104). A collar example and front leg example are illustrated in FIG. 19. Those skilled in the art will appreciate that other placement locations are possible. The benefits of the present disclosure can be seen not only via the animal's improved demeanor and attention, but objectively as well via an EEG or other tests.

The disclosed methods and systems provide asynchronous (or continuous) alternating bilateral stimulation to support the reduction of chronic stress and other physiologic and psychiatric disorders in patients. It will be appreciated that the disclosed asynchronous methods and systems provide an advantage with the overlapping time period of simultaneous stimulation which enhances the bi-lateral impact in the somatosensory areas of the patient's brain. It will also be appreciated that the disclosed continuous methods and systems provide an advantage by not allowing time for the patient's brain to activate the somatosensory areas of the individual's brain. The disclosed asynchronous and continuous bi-lateral stimulations regimes provides an advantage over conventional bi-lateral stimulators in ensuring that the stimulation gap commonly used in conventional bi-lateral stimulators will not allow the brain to activate the sympathetic system.

It will be appreciated that the various illustrative logical blocks/tasks/steps, modules, circuits, and method steps described in connection with the embodiments disclosed herein may be implemented as electronic hardware, computer software, or combinations of both. Some of the embodiments and implementations are described above in terms of functional and/or logical block components or modules and various processing steps. However, it should be appreciated that such block components or modules may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope as set forth in the claims.

For example, an embodiment of a system or a component may employ various integrated circuit components, for example, memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The word exemplary is used exclusively herein to mean serving as an example, instance, or illustration. Any embodiment described herein as “exemplary” is not necessarily to be construed as preferred or advantageous over other embodiments.

The steps of a method described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC.

In this document, relational terms such as first and second, and the like may be used solely to distinguish one entity or action from another entity or action without necessarily requiring or implying any actual such relationship or order between such entities or actions. Numerical ordinals such as first, second, third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as connect or coupled to that are used in describing a relationship between different elements does not imply that a direct physical connection must be made between these elements. For example, two elements may be connected to each other physically, electronically, logically, or in any other manner, through one or more additional elements.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing the exemplary embodiment or exemplary embodiments.

What is claimed is:

1. A method for providing a therapeutic benefit to a patient, comprising:
(a) positioning a first tactile stimulator in therapeutic contact with a body of a patient;
(b) positioning a second tactile stimulator in therapeutic contact with the body of the patient in a bilateral position to the first tactile stimulator;
(c) activating, via a controller, the first tactile stimulator to provide a first stimulation for a first time period;
(d) activating, via the controller, the second tactile stimulator to apply a second stimulation for a second time period beginning at least commensurate with a cessation of the first time period;
(e) repeating steps (c) and (d) for a therapeutically effective number of repetitions;
whereby, the first and second stimulations are applied bilaterally to the body of the patient without a patient perceivable pause in stimulation between the first stimulation and second stimulation to provide the therapeutic benefit to the patient.

2. The method of claim 1, wherein the first stimulation and second stimulation are substantially uniform in speed and intensity during the first time period and the second time period, respectively.

3. The method of claim 1, wherein the first stimulation and second stimulation are substantially uniform in speed and increase in intensity during the first time period and the second time period, respectively.

4. The method of claim 1, wherein the first stimulation and second stimulation are substantially uniform in intensity and increase in speed during the first time period and the second time period, respectively.

5. The method of claim 1, wherein the first stimulation and second stimulation increase in intensity and speed during the first time period and the second time period, respectively.

6. The method of claim 1, wherein the first stimulation and second stimulation are substantially uniform in intensity and decrease in speed during the first time period and the second time period, respectively.

7. The method of claim 1, wherein the first stimulation and second stimulation are substantially uniform in speed and decrease in intensity during the first time period and the second time period, respectively.

8. The method of claim 1, wherein the first stimulation and second stimulation decrease in intensity and speed during the first time period and the second time period, respectively.

9. The method of claim 1, wherein the first stimulation and the second stimulation are vibratory stimulations.

10. The method of claim 1, where the second stimulation commences prior to the cessation of the first stimulation.

11. The method of claim 1, where the patient comprises a human patient.

12. The method of claim 1, where the patient comprises a veterinary patient.

13. A system for providing a therapeutic benefit to a patient, comprising:
first and second tactile stimulators bilaterally positioned in therapeutic contact with a body of a patient;
a controller communicably coupled to the first and second tactile simulators, the controller causing the first tactile stimulator to apply a first stimulation for a first time period and causing the second tactile stimulator to apply a second stimulation for a second time period beginning at least commensurate with a cessation of the first time period;
wherein, the first and second stimulations applied bilaterally to the body of the patient without a patient perceivable pause in stimulation between the first stimulation and second stimulation provide the therapeutic benefit to the patient.

14. The system of claim 13, wherein the first and second tactile stimulators comprise vibrating elements.

15. The system of claim 13, wherein the first and second tactile stimulators are communicably coupled to the controller via wireless communication.

16. The system of claim 13, wherein at least one of the first and second tactile stimulators are mounted in hand-held devices.

17. The system of claim 13, wherein at least one of the first and second tactile stimulators are mounted in patient wearable devices.

18. The system of claim 13, wherein the controller operates to apply the second stimulation prior to the cessation of the first stimulation.

19. The system of claim 13, wherein the controller operates to vary at least one of stimulation speed and stimulation intensity of the first and second stimulation over the first and second time period, respectively.

20. A non-transitory computer readable medium embodying a computer program product, the computer program product comprising:
instructions for providing a therapeutic benefit to a patient when executed by a processor, the instructions causing the processor to communicate with first and second tactile stimulators bilaterally positioned on the patient's body and activate the first tactile stimulator to apply a first stimulation for a first time period and activate the second tactile stimulator to apply a second stimulation for a second time period beginning at least commensurate with the processor instructing the first tactile stimulator to cease applying the first stimulation;
whereby, the instructions cause the first and second stimulations to apply alternating bilateral stimulation to the patient without a patient perceivable pause in stimulation between the first stimulation and second stimulation to provide the therapeutic benefit to the patient.
